(19) United States
(12) Patent Application Publication
(10) Pub. No.: US 2013/0045863 A1
(43) Pub. Date: Feb. 21, 2013

(54) COMPLEX AND METHOD OF PREPARATION

(71) Applicants: Alan Thomas Cooper, Wingate (GB); Mark Dixon, Redcar (GB)

(72) Inventors: Alan Thomas Cooper, Wingate (GB); Mark Dixon, Redcar (GB)

(73) Assignee: JOHNSON MATTHEY PLC, London (GB)

(21) Appl. No.: 13/578,135

(22) PCT Filed: Jan. 19, 2011
(86) PCT No.: PCT/GB2011/050079

§ 371 Date: Oct. 31, 2012

(30) Foreign Application Priority Data
Feb. 11, 2010 (GB) 1002278.8

(51) Int. Cl. C08F 4/76; C07F 7/28

(52) U.S. Cl. 502/152; 556/41; 556/52

(57) ABSTRACT

A composition has an empirical formula M (glycerol) a (X) b, where M represents a metal atom selected from titanium, zirconium, hafnium or aluminium, X is a ligand derived from acetylacetone or a peroxo ion; a is a number between 1 and 2. 5; b is a number in the range from 1 to 2. An alternative composition results from the reaction of a compound of titanium, zirconium, hafnium or aluminium with (a) glycerol and (b) either: (i) acetylacetone or (ii) hydrogen peroxide, an inorganic base and water. The composition is useful in applications requiring water-stable metal chelates, particularly as a catalyst for esterification and polyurethane reactions.

The present invention relates to compounds or compositions of titanium, zirconium, hafnium or aluminium with glycerol, methods of making such compounds and compositions and uses of them as catalysts and cross linkers in various industrial applications.

Organic compounds of titanium, zirconium, hafnium and aluminium are well known for use as catalysts, e.g. for catalysing esterification and polyurethane reactions, cross-linkers, e.g. for coatings and well fracturing fluids, and as adhesion promoting compounds for printing inks. It is an object of the invention to provide a novel liquid compound which is stable in water.

According to the invention, we provide a composition having an empirical formula M(glycerol)ₐ(X)_{b}, where M represents a metal atom selected from titanium, zirconium, hafnium or aluminium, X is a ligand derived from acetylacetone or a peroxo ion; a is a number between 1 and 2.5; and b is a number in the range from 1 to 2.

According to a second aspect of the invention we provide a composition resulting from the reaction of a compound of titanium, zirconium, hafnium or aluminium with
(a) glycerol and
(b) either:
   (i) acetylacetone or
   (ii) hydrogen peroxide, an inorganic base and water.

The resulting compositions are water stable and active as catalysts and cross-linkers. Catalysts and cross-linkers based on the compositions of the invention are beneficial in some applications because they can be handled as liquids or in solution and are stable in contact with water. Therefore when used in polyurethane manufacture, for example, the catalysts can be added to a polyol formulation without degrading the activity of the catalyst.

In the formula M(glycerol)ₐ(X)_{b} we use (glycerol) to denote a ligand derived from glycerol, usually (CH₂OHCH(OH)CH₂O)⁻. In preferred compositions, a≧2. We have found that when at least 2 mols of glycerol-derived ligands are present per mole of metal, the resulting composition is stable in water and can be dehydrated and then rehydrated to reform a stable aqueous solution. When less than 2 mols of glycerol-derived ligands are present per mole of metal, then we have found the composition forms a stable solution in water but, if water is removed to dryness, a subsequent rehydration is only partially successful. Excess glycerol may be present in the composition but it is unlikely to be bound to the metal centre, i.e. it would function as a diluent.

When X represents a ligand derived from acetylacetone, b=2 when the formula is stoichiometric. b may be greater than 2 in an empirical formula when the composition includes an excess of the acetylacetone, which would serve as a diluent in the composition. When X represents a ligand derived from a peroxo ion, b=1 when the formula is stoichiometric because each peroxo ion has a charge of −2. If excess peroxide is added then it decomposes to form oxygen. The composition may be prepared using an excess of hydrogen peroxide. An appropriate amount of the added peroxide forms a peroxide ion and binds to the metal centre whilst the remainder decomposes.

The metal M is selected from any metal capable of forming a covalent metal-oxygen bond. Particularly preferred metals include titanium and zirconium, especially titanium. Suitable metal compounds include metal halides, metal alkoxides, metal halo-alkoxides, metal carboxylates and mixtures of these compounds. Typical alkoxides have the general formula M(OR)_{y} in which M is Ti, Zr, Hf, or Al, y is the oxidation state of the metal, i.e. 3 or 4, and R is a substituted or unsubstituted, cyclic or linear, alkyl, alkenyl, aryl or alkyl-aryl group or mixtures thereof. Preferably, R contains up to 8 carbon atoms and, more preferably, up to 6 carbon atoms. Generally, all OR groups are identical but alkoxides derived from a mixture of alcohols can be used and mixtures of alkoxides can be employed when more than one metal is present in the complex. When the metal is titanium, preferred titanium compounds include titanium alkoxides having a general formula Ti(OR)₄ in which R is an alkyl group, preferably having from 1 to 8 carbon atoms and each R group may be the same as or different from the other R groups. Particularly suitable metal compounds include titanium tetrachloride, titanium tetra-isopropoxide, titanium tetra-n-propoxide, titanium tetra-n-butoxide, titanium tetraethoxide (tetraethyl titanate), zirconium n-propoxide, zirconium butoxide, hafnium butoxide, aluminium sec-butoxide, aluminium trichloride, aluminium trimethoxide, aluminium triethoxide, aluminium tri-isopropoxide and aluminium tri-n-propoxide.

The inorganic base is preferably an alkali metal, alkaline earth metal or ammonium hydroxide. The function of the base is to deprotonate the hydrogen peroxide ligand allowing it to bond more easily as O₂²⁻. Therefore other bases may be suitable so long as they are able to function in this way. Preferred bases include sodium hydroxide, potassium hydroxide and ammonium hydroxide. The amount of base present is preferably sufficient to provide at least 0.5 moles of cation (e.g. Na⁺, K⁺ or NH₄⁺) per mole of metal M. When M is titanium and the base is sodium hydroxide, we have found that when at least 0.56 moles of sodium are present per mole of titanium, the resulting composition forms a stable aqueous solution which yields a crystalline solid on drying, the solid being capable of being re-dissolved in water. We have found that when 2 or more moles of base are present per mole of metal, then the composition is less stable in water, particularly when heated.

The compounds are preferably made by first reacting together the metal compound and the reactants (b), i.e. either the acetylacetone or the hydrogen peroxide, inorganic base and water, followed by reaction of the resulting mixture with the glycerol.

The catalysts used in the invention may be supplied neat (particularly when the composition is, itself a liquid) or supplied as a formulated composition containing a solvent or diluent, which may be present in quantities representing up to 90% of the weight of the total catalyst composition (i.e. including the diluent), more preferably up to 50% by weight. The solvent or diluent may comprise water, an alcohol, diol or polyol, another protic solvent or a glycerol-based oil, especially naturally derived oils such as castor oil, rape-seed oil etc.

The compositions and methods of making them will be described in the following non-limiting examples.

### EXAMPLE 1

Ti(glycerol)₂(acac)₂.4(ⁱPrOH)

Acetylacetone (353 mg, 3.52 mmol) was added to 500 mg (1.76) mmol of tetraisopropyl titanate (VERTEC™ TIPT available from Johnson Matthey PLC—hereinafter “TIPT”) with stirring. The reaction was exothermic and resulted in a clear yellow/red solution. Glycerol (324 mg, 3.52 mmol) was added to the solution to give a clear yellow solution. This product remained as a mobile, clear liquid even upon heating at 50° C. for 1 hour. The product described above was dissolved into water as a 10 w/w % solution, to give a clear yellow solution. The aqueous solution remained unchanged for greater than 3 months at ambient temperature. The aqueous solution was heated at 60° C. for 1 hour, to give a hazy solution, suggesting hydrolysis of the titanium complex had occurred.

### EXAMPLE 2

Ti(glycerol)₂(acac)₂

Acetylacetone (353 mg, 3.52 mmol) was added to TIPT (500 mg, 1.76 mmol) with stirring. The reaction was exothermic and resulted in a clear yellow/red solution. Glycerol (324 mg, 3.52 mmol) was added to the solution to give a clear yellow solution. The product was distilled at 80° C., under reduced pressure to remove the isopropanol resulting in a highly viscous, clear liquid (760 mg). The product was dissolved in water as a 10 w/w % solution, to give a clear yellow solution and also a yellow precipitate. The yellow precipitate dissolved upon further addition of water (approximately 1 w/w % aqueous solution). The aqueous solution remained unchanged for greater than 3 months at ambient temperature. The aqueous solution was heated at 60° C. for 1 hour, to give a hazy solution, suggesting that hydrolysis of the titanium complex had occurred.

### EXAMPLE 3

[Ti(O₂)(glycerol)₂][NH₄]

500 mg TIPT (1.76 mmol) was dissolved into a clear, colourless solution consisting of aqueous hydrogen peroxide (684 mg, 7.04 mmol, 35 wt %), aqueous ammonia (224 mg, 5.28 mmol, 33wt% solution) and water (10 g). A clear yellow solution was formed. Aqueous glycerol (1.296 g, 3.52 mmol, 25 wt % solution) was added to the reaction mixture and stirred for 30 minutes, resulting in a clear yellow solution. The solution was then heated at 80° C. for 5 minutes to decompose any remaining hydrogen peroxide. This solution was shown to not change in colour, viscosity or clarity for a time period greater than 12 weeks.

### EXAMPLE 4

The complex formed in Example 3 was evaporated to dryness at 80° C. under reduced pressure, resulting in a yellow solid. A yellow transparent aqueous solution having a neutral pH reading (pH=7±0.5) was prepared by adding distilled water to the solids. The solution was again evaporated to dryness and then reformed by adding distilled water to the dry yellow solid.

### EXAMPLE 5

Ti:glycerol:peroxo:NH₄=1:1:4:3

TIPT (500 mg, 1.76 mmol) was dissolved into a clear, colourless solution consisting of aqueous hydrogen peroxide (684 mg, 7.04 mmol, 35 wt %), aqueous ammonia (224 mg, 5.28 mmol, 33 wt %) and water (10 g). A clear yellow solution was formed. Aqueous glycerol (648 mg, 1.76 mmol, 25 wt %) was added to the reaction mixture and stirred for 30 minutes, resulting in a clear yellow solution. The solution was then heated at 80° C. for 5 minutes to decompose any remaining hydrogen peroxide leaving a clear yellow solution that remained stable for more than 3 days.

### EXAMPLE 6

Ti:glycerol:peroxo:Na=1:2:4:2

TIPT (500 mg, 1.76 mmol) was dissolved into a clear, colourless solution consisting of aqueous hydrogen peroxide (684 mg, 7.04 mmol, 35 wt %), aqueous sodium hydroxide (440 mg, 3.52 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution became hazy when the water was removed at 80° C., under reduced pressure. The solution measured pH 11.

### EXAMPLE 7

Ti:glycerol:peroxo:Na=1:2:4:1 (Na[Ti(O—O)(glycerol)₂])

TIPT (500 mg, 1.76 mmol) was dissolved into a clear, colourless solution consisting of aqueous hydrogen peroxide (684 mg, 7.04 mmol, 35 wt %), aqueous sodium hydroxide (220 mg, 1.76 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution remained unchanged with respect to colour and clarity when the water was removed at 80° C., under reduced pressure. Complete removal of water resulted in a yellow solid, which readily re-dissolved in water to provide a clear yellow solution of pH 11.

### EXAMPLE 8

Ti:glycerol:peroxo:Na=1:2:4:0.56

TIPT (500 mg, 1.76 mmol) was dissolved into a clear, colourless solution consisting of aqueous hydrogen peroxide (684 mg, 7.04 mmol, 35 wt %), aqueous sodium hydroxide (123 mg, 0.98 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution remained unchanged with respect to colour and clarity when the water was removed at 80° C., under reduced pressure. Complete removal of water resulted in a yellow solid, which readily re-dissolved in water to provide a clear yellow solution having a measured pH of 8. Likely structure: [Ti(O₂)(glycerol)₂][Na]_{0.56}. This composition may also be represented as 0.56 Na[Ti(O—O)(glycerol)₂]+0.44 Ti(O—O)(glycerol)₂, i.e. as a mixture.

### EXAMPLE 9

Ti:glycerol:peroxo:Na=1:2:4:0.55

TIPT (500 mg, 1.76 mmol) was dissolved into a clear, colourless solution consisting of aqueous hydrogen peroxide (684 mg, 7.04 mmol, 35 wt %), aqueous sodium hydroxide (121 mg, 0.97 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution became hazy during heating.

### EXAMPLE 10

Preparation of Polyester

A catalyst solution was formed by making an aqueous solution of [Ti(O₂)(glycerol)₂][Na]_{0.56}, as prepared in Example 8, at a concentration to give a total Ti concentration in the solution of 2.1 wt. %.

The catalyst solution was used to prepare a polyester. Ethylene glycol was mixed with a mixture of terephthalic acid (98 wt %) and isophthalic acid (2 wt %) in an autoclave, the mol ratio of ethylene glycol:phthalic acids being 1.2. Sufficient catalyst solution was added in ethylene glycol to provide a titanium concentration of 7 ppm in the polyester. The mixture was reacted at a temperature of 260° C. and a pressure of 40 psig (276 MPa) in a conventional esterification procedure, wherein water was continuously removed from the reaction mixture, to form bishydroxyethyl terephthalate. The “DE time”, i.e. time to complete the direct esterification reaction (when water was no longer produced) was 89 minutes. The resulting monomer was then polycondensed at a temperature of 290° C. and under vacuum (<1 mbar (<100 Pa)) with the removal of ethylene glycol as is conventional. The time taken to attain an intrinsic viscosity (IV) of 0.62, “PC time”, was 112 minutes. The polymer was removed from the reactor and cut into chips. Intrinsic viscosity values are calculated from solution viscosity measurements by extrapolation to zero concentration. The measurements are determined using as solvent a mixture of 60% (by weight) phenol and 40% tetrachloroethane (3:2 PTCE) at 30° C. The method follows ISO 1628-5:1998.

The colour was measured using Hunter b-value is obtained using the method of ASTM D6290-05 “Standard Test Method for Color Determination of Plastic Pellets”. The method employed uses a BYK COLORVIEW instrument which provides the reading of b-value according to the Hunter scale directly. The colour is shown in the table below.

### EXAMPLE 11

Preparation of Polyester

Example 10 was repeated but the polycondensation was continued until an IV of 0.75 had been attained and the PC time is the time to reach this IV. The results are shown in the table.

| | DE time | PC time | | | |
|---|---|---|---|---|---|
| Example | (mins) | (mins) | L* | a* | b* |
| 10 | 89 | 112 | 74.33 | −2.69 | 9.1 |
| 11 | 85 | 150 | 75.7 | −3.09 | 14.9 |

### EXAMPLE 12

Preparation of Polyurethane Elastomer with Polyester Polyol

A 50 wt. % solution of Ti(acac)₂(glycerol)₂ in diethylene glycol was used as a catalyst in the following polyurethane elastomer system:
Polyester polyol:Diorez™ PR3:48.94 g
Chain extender:1,4-butane diol (1,4-BDO):5.44 g
Isocyanate:Diprane™ 53 (Dow):45.62 g
DIOREZ and DIPRANE are trademarks of Dow Hyperlast.

The polyester polyol was mixed with the chain extender and the mixture was dried at 90° C. under vacuum and allowed to equilibrate for 12 hours before use. The catalyst (0.054 g) was added to the mixture of polyol and chain extender (at 40° C.) to provide a concentration of 0.1 wt. % (based on total weight of polyol and chain extender) and mixed on a centrifugal mixer for 30 seconds. The isocyanate (at 40° C.) was then added to the polyol/catalyst mixture and mixed on a centrifugal mixer for 30 seconds. The mixture was poured into a disposable metal pot and the gel-time was recorded using a Gardco gel timer with the heated mould set at 80° C. The gel time was measured as 288 seconds.

### EXAMPLE 13

Preparation of polyurethane elastomer with polyether polyol

A 50 wt. % solution of Ti(acac)₂(glycerol)₂ in diethylene glycol was used as a catalyst in the following polyurethane elastomer system:
Polyol 1: polypropylene glycol (PPG) 4.8K triol:27.0 g
Polyol 2: Voranol™ EP1900:27.0 g
Chain extender: 1,4-BDO:6.01 g
Isocyanate: 90:10 Lupranate™ MP102:Lupranate MM103:29.9 g
VORANOL is a trademark of the Dow Chemical Company. LUPRANATE is a trademark of BASF.

The catalyst (0.03 g) was added to the mixture of polyols and chain extender at room temperature, to provide a concentration of 0.05 wt. % (based on the total weight of polyol and chain extender) and mixed on a centrifugal mixer for 30 seconds. The room temperature isocyanate was then added to the polyol/catalyst mixture and mixed on a centrifugal mixer for 30 seconds. The mixture was poured into a disposable paper pot and the gel-time was recorded at room temperature using a Gardco gel timer. The gel time was measured as 250 seconds.

### Example 14

Preparation of Polyurethane Elastomer with Castor Oil/PPG.

A 50 wt. % solution of Ti(acac)₂(glycerol)₂ in diethylene glycol was used as a catalyst in the following polyurethane elastomer system using as a polyol a 90:10 castor oil:PPG formulation:
Polyol 1:castor oil:50.0 g p0 Polyol 2:PPG 2K diol:5.60 g
Isocyanate:Diprane™ 5046:24.5 g

The procedure described in Example 13 was followed, using 0.278 g of catalyst to provide a concentration of 0.05 wt. % catalyst (based on the polyol and castor oil). The gel time was measured as 815 seconds.

1. A composition having an empirical formula M(glycerol)ₐ(X)_{b}, where M represents a metal atom selected from the group consisting of titanium, zirconium, hafnium and aluminium, X is a ligand derived from acetylacetone or a peroxo ion; a is a number between 1 and 2.5; and b is a number in the range from 1 to 2.

2. The composition according to claim 1 comprising a compound of formula M(glycerol)₂(peroxo)₁.

3. The composition according to claim 1 comprising a compound of formula M(glycerol)₂(peroxo)₁[A]_{0.56-2} where A is selected from the group consisting of sodium, potassium and ammonium.

4. The composition according to claim 1 comprising a compound of formula M(glycerol)₂(acetylacetonato)₂, where M represents a metal atom selected from the group consisting of titanium, zirconium and hafnium.

5. The composition according to claim 1 comprising a compound of formula M(glycerol)₂(acetylacetonato)₁, where M represents an aluminium atom.

6. The composition according to claim 4, further comprising free acetylacetone.

7. The composition according to claim 1, further comprising free glycerol.

8. The composition according to claim 1, wherein the composition is present in an aqueous solution.

9. The composition according to claim 1, in the form of a dry solid.

10. A method of manufacturing a water stable metal-organic composition comprising the steps of (a) reacting a compound of titanium, zirconium or hafnium with either
(i) acetylacetone or
(ii) hydrogen peroxide, an inorganic base and water; and
(b) reacting the composition resulting from step (a) with glycerol.

11. The method according to claim 10, wherein the molar ratio of titanium, zirconium or hafnium:acetylacetone:glycerol is 1:at least 2:1 ->2.5.

12. The method according to claim 10, wherein the molar ratio of titanium, zirconium or hafnium:hydrogen peroxide:base:glycerol is 1:1:0.56-2:1->2.5.

13. The composition according to claim 5, further comprising free acetylacetone.
